(19) United States
(12) Patent Application Publication
(10) Pub. No.: US 2017/0205091 A1
(43) Pub. Date: Jul. 20, 2017

(54) A METHOD FOR DEHUMIDIFICATION OF AIR AND SYSTEM THERETO

(71) Applicant: 2NDAIR B.V., Voorburg (NL)

(72) Inventor: Robertus Wilhelmus Jacobus HOLLERING, Voorburg (NL)

(21) Appl. No.: 14/901,405

(22) PCT Filed: Sep. 30, 2015
(86) PCT No.: PCT/NL2015/050684

§ 371 Date: Dec. 28, 2015

(30) Foreign Application Priority Data
Oct. 7, 2014 (NL) 2013586

(51) Int. Cl. F24F 3/14; B01D 53/14; B01D 53/26; F24F 3/147

(52) U.S. Cl. CPC F24F 3/1417; F24F 3/147; F24F 3/1429; B01D 53/1425; B01D 53/263; F24F 2003/1458; F24F 2003/1435

(57) ABSTRACT

The air-conditioning system comprises a dehumidification module and a regeneration module, that are arranged such that a first flow of liquid desiccant material may run in a cycle between those. The system also comprises a first container for the liquid desiccant material for supply into the dehumidifier module. Furthermore, the system is provided with a second regeneration module for generation of a second flow of liquid desiccant material and a second container for storage of desiccant material with an entry for the dehumidified second flow. It further comprises mixing means for mixing desiccant material from the second container into the first container and/or with the first flow upstream of the dehumidifier module. Particularly, the second flow is heated prior to regeneration by means of a heat-exchanger drawing heat—directly or indirectly—from a cooling liquid of a fuel-driven generator

### CROSS REFERENCE TO RELATED APPLICATIONS

This application is a 371 national stage application of PCT Patent Application No. PCT/NL2015/050684, entitled “A method for dehumidification of air and system thereto,” filed on Sep. 30, 2015, which claims priority to Dutch Patent Application No. 2013586 filed on Oc. 7, 2014, the entire contents of which are incorporated herein by reference.

### FIELD OF THE INVENTION

The invention relates to method of dehumidifying air, wherein use is made of a heat and mass exchange module comprising a plurality of air channels for air flow and a plurality of liquid channels for flow of liquid desiccant material, in which heat and mass exchange module a liquid channel is arranged adjacent to an air channel with a mutual exchange surface, which method comprises the steps of:
Supplying a first flow of liquid desiccant material into liquid channels of the heat and mass exchange module for exchange with an air flow at the mutual exchange surface, resulting in a dehumidified air flow and in humidification of the liquid desiccant material to a second humidity content, and
Regenerating the first flow for supply into the heat and mass exchange module.
The invention also relates to a system comprising:
a heat and mass exchange module comprising a plurality of air channels for air flow and a plurality of liquid channels for flow of liquid desiccant material, in which heat and mass exchange module a liquid channel is arranged adjacent to an air channel with a mutual exchange surface, and
means for dehumidification of a first flow of liquid desiccant material downstream of the heat and mass exchange module;

### BACKGROUND OF THE INVENTION

Liquid desiccant-based air conditioners are considered a promising energy-efficient alternative for existing air-conditioning systems. The liquid desiccant allows the absorption of humidity. Moreover, the liquid desiccant may be easily transported, so that the cooling or drying of air may be carried out at different locations. The air-conditioner suitably comprises a heat and mass exchange (hereinafter also HMX) module for dehumidification and for regeneration. These HMX modules are typically used in combination with evaporators for cooling of air.

For sake of clarity, the term ‘HMX-module’ is used within the context of the present invention to refer to any module for use in a conditioning system for air and/or another gas. Where reference is made to an air-conditioner module, this is to be understood as synonym. The conditioning system may be arranged to condition humidity and/or temperature of the air. The conditioning system is typically used for air, such as available in offices, stables, houses, theatres, museums, sport halls, swimming pools and other buildings. The conditioning system may alternatively be used for conditioning an industrial gas flow.

A typical example of liquid desiccant is a concentrated salt solution of LiCl. Such a salt solution however have as disadvantages that LiCl may be hazardous for human health and that the concentrated LiCl solution is highly corrosive. It is therefore to be avoided that the LiCl is carried over into the air during the air-conditioning. The liquid desiccant is therefore often used in combination with a membrane, such as for instance known from WO2009/094032A1. Another option is the use of a porous material, more particularly a wicking material. Such modules are for instance known from WO00/55546 (Drykor), and from WO2013/094206.

After use of the liquid desiccant material for dehumidification, the material needs to be regenerated. This means that the humidity content is again reduced. Typically, use is made of a regeneration module, which may be based on the same design as the heat and mass exchange. Suitably, a regeneration module comprises a plurality of air channels and a plurality of liquid channels. In order to get the added humidity out of the liquid desiccant material, this material is heated prior to entry into the regeneration module. Suitably, relatively dry air is used for the absorption of humidity in the regeneration module. This is for instance indoor air, which is to be disposed out of the building. Alternatively, outdoor air could be used. Particularly in hot and humid climates, such as tropical climates, such outdoor air however is already quite humid, such that it will absorb humidity only with lower efficiency. After the regeneration, the liquid desiccant is again cooled, so as to prepare it for a new cycle.

In order to improve the efficiency of the heating and subsequent cooling of the liquid desiccant material, the use of a heat pump is known, for instance from WO99/26025A1.

This heat pump is coupled between the flows of liquid desiccant material upstream and downstream of the regeneration module. Therewith, the efficiency of the process may be improved, but at the cost of operating an additional heat pump. In practice, it has been found that the energy consumption of a heat pump is significant, and much larger than the energy consumption needed for the pump used for recirculation of the liquid desiccant material. However, the temperature of the liquid desiccant material leaving the regeneration module may well be over 50° C. A flow of this temperature cannot be simply heat exchanged with natural water, such as water in sea, lake or river, in view of environmental protection; if the volume is too big, the ecosystem in the water may well be damaged. Adding a flow of refrigerant may be an option, but this adds costs and complexity.

### SUMMARY OF THE INVENTION

It is therefore an object of the present invention to provide an improved method and an improved system, in which the use of a heat pump may be avoided, while still allowing to regenerate the first flow of liquid desiccant material, so that it has appropriate humidity content and temperature for supply to the heat and mass exchange module for dehumidification of an air flow.

According to a first aspect of the invention, this object is achieved in a method of dehumidifying air, wherein use is made of a heat and mass exchange module comprising a plurality of air channels for air flow and a plurality of liquid channels for flow of liquid desiccant material, in which heat and mass exchange module a liquid channel is arranged adjacent to an air channel with a mutual exchange surface, which method comprises the steps of: (1) providing liquid desiccant material with a first humidity content into a first container; (2) supplying a first flow from the first container into liquid channels of the heat and mass exchange module for exchange with an air flow at the mutual exchange surface, resulting in a dehumidified air flow and in humidification of the liquid desiccant material to a second humidity content; (3) regenerating the first flow, and (4) adding the regenerated liquid desiccant material into the first container for supply into the heat and mass exchange module. According to the invention, the regenerating process comprises the steps of:
Dehumidifying the first flow with the second humidity content to a third humidity content;
Dehumidifying a second flow of liquid desiccant material to a fourth humidity content, which is at most equal to the first humidity content;
Storing the second flow with the fourth humidity content in a second container;
Mixing a third flow of liquid desiccant material from the second container with the first flow with the third humidity content to obtain a liquid desiccant material of the first humidity content.

According to a second aspect, the invention provides a system comprising (1) a heat and mass exchange module comprising a plurality of air channels for air flow and a plurality of liquid channels for flow of liquid desiccant material, in which heat and mass exchange module a liquid channel is arranged adjacent to an air channel with a mutual exchange surface; (2) a first container for liquid desiccant material for supply into liquid channels of the heat and mass exchange module; (3) means for dehumidification of a first flow of liquid desiccant material downstream of the heat and mass exchange module; (4) means for dehumidification of a second flow of liquid desiccant material; (5) a second container for storage of liquid desiccant material with an entry for the dehumidified second flow; (6) mixing means for mixing liquid desiccant material from the second container into the first container and/or with the first flow downstream of the means for dehumidification.

The present invention is based on the insight that a heat pump may be left out by combining a first flow from a regenerator module (or more generally means for dehumidification) with a third flow that has been regenerated separately, and typically over a larger time span. As a result, the humidity content of the third flow may be lower than that of the first flow after regeneration. Combining those in adequate ratios, suitably controlled by means of a controller, reduces the requirements of the regeneration of the first flow. The temperature of the regenerated first flow may thus be reduced relative to the situation known from the prior art, thus minimizing the need for a heat pump. Furthermore, in one suitable embodiment, the temperature of the regenerated first flow may further be reduced by means of heat exchange with the second flow upstream of the regeneration thereof.

Beyond reducing the need for a heat pump, the liquid desiccant material may be advantageously used in accordance with the invention to improve operation. Particularly, in one embodiment, the start-up time of the system may be reduced in that the first reservoir is primarily or even completely fed with concentrated liquid desiccant material from the second reservoir. Furthermore, in a further embodiment, if there is a need for enhanced dehumidification of the air, concentrated liquid desiccant from the second container is fed into the first container in a higher ratio. Herewith, the overall concentration of liquid desiccant material may be increased, but also the overall level of liquid desiccant material may be increased, therewith raising the pressure, and thus the pressure drop. In again a further embodiment, the feeding of the concentrated liquid desiccant is reduced to a minimum or even stopped, and the dehumidification process may run on the basis of the regeneration of the first flow only.

One of the advantages of the use of the second container for storage is that the storage duration provides a larger variety of options for cooling down the liquid desiccant material. For instance, the second container may be present in a water bath or even a suitable flow of water so as to cool down the liquid desiccant material gradually. Furthermore, the second container may be provided with a heat sink for removal of heat. The liquid desiccant material may further be circulated in an additional circuit with heat sinks and/or heat exchangers for temperature reduction. Furthermore, such temperature reduction is further deemed effective for operation in climates that are humid and have relative low temperatures, for instance at temperatures below 20° C. , more preferably below 14 or 12 or 10° C., or even around freezing temperatures. The current system using liquid desiccant is very suitable therefore, since the liquid desiccant has a lower freezing temperature, and the longer period for cooling down enables an efficient operation, for instance by cooling the liquid desiccant against outside air, and/or in a cooling down procedure that involves more than one step, such as first cooling down in a water bath, and thereafter further cooling down outside, and/or in a heat exchanger using outside air or water from outside.

Furthermore, in one suitable embodiment, the second container may be decoupled when filled to a predetermined level. This allows the filling of several containers with a single means of dehumidification of the liquid desiccant. Moreover, such decoupling allows transportation of the second container in its entirety. In certain applications, transportation of a container may be more beneficial than the provision of a piping system for transportation of liquid desiccant material in relatively high concentration. The transportation of a container may for instance be suitable when the typically aqueous solution of desiccant material is concentrated to above the solubility limit, and the desiccant material solidifies, particularly by means of crystallisation. In one implementation, a separation step may be carried out between a (partly) crystallized phase and a liquid phase of the crystallized liquid desiccant material.

Either the liquid phase or the crystallized phase is then transported to the first container. The use of the liquid phase may be beneficial. Particularly, crystallisation of a desiccant material, such as a salt, more particularly a Li-salt, such as LiCl, requires heat and thus cools the system. The remaining liquid phase, that is thus cooled, will typically be at or close to the solubility limit. When dissolving crystallized Li-salt, the heat of crystallisation will be liberated again, giving rise to a temperature increase. However, when using the liquid phase, no such liberation will occur. Notwithstanding, the use of the crystallized phase may well be beneficial for certain applications.

The term ‘mixing’ in the context of the present invention is therefore understood as feeding the first flow and/or the third flow in mutual ratio, as suitably defined by means of a controller into the first container, and furthermore ensuring that the liquid desiccant material in the first container is sufficiently homogeneous, i.e. without significant differences in humidity content. In one embodiment, the first flow and the third flow are first brought together and then fed into the first container. In this embodiment, a separate mixing vessel may be foreseen, but that is not strictly necessary. In another embodiment, the first flow and the third flow are supplied into the first container separately and then mixed with the liquid desiccant material already present. The best mixing will depend on a difference in humidity content between the first and the third flow and the intended mixing ratios. One specific condition is wherein the third flow of desiccant material is at least partially in solidified form, i.e. the concentration of the—suitably aqueous—solution of desiccant is increased above the solidification and particularly the crystallisation concentration. In this situation, thorough mixing may be necessary, so as to dissolve such crystals of desiccant.

The term ‘at most equal’ is intended to cover the situation that the liquid desiccant in the second container has substantially the same concentration as that in the first container. In such a situation, the contribution of the third flow is a reduction in the first flow, limiting the need for pumping heat, or enabling heat exchange of the regenerated and heated-up first flow by means of conventional heat exchangers. However, it is preferred that the humidity content in the second container is lower than that in the first container. It is even more preferred that the humidity content of the first flow downstream of the regeneration module is higher than that in the first container.

In one preferred embodiment, the dehumidification of the second flow of liquid desiccant material comprises the steps of:
Heating the second flow in a heat exchanger against a flow of cooling liquid from a fuel-driven generator to a first temperature;
Dehumidifying the second flow at the first temperature.

It has been found in experiments leading to the invention that the use of heat generated by a fuel-driven generator, such as a diesel generator, is efficiently used for heating up the second flow of liquid desiccant material. Diesel generators are in use in many locations that are not connected to the electricity grid. They serve to generate electricity. In addition to the electricity, a lot of heat is generated, which is often merely dissipated by means of the cooling liquid. A radiator may be used to reduce the temperature of the cooling liquid, usually supported by an air flow generated by a fan—driven by the generator and thus at the expense of efficiency of the generator. The transmission of the heat from the cooling liquid of the generator to the second flow of liquid desiccant material is not merely a beneficial use of this heat. It has been understood by the inventors that the second flow of liquid desiccant material to be regenerated and stored into the second container matches the time-scale and properties of the generator appropriately. First of all, a generator is a device that slowly warms up and cools down. Since the second flow is regenerated and supplied to a second container, the progress of the regeneration can be coupled to the available heat. In one further embodiment, the flow rate of the second flow is set so as to heat the second flow to a predefined temperature. Secondly, the temperature for regeneration of the liquid desiccant corresponds well to the temperature of the cooling liquid of a fuel-driven generator, particularly in the range of 70 to 110° C. Temperatures of 70-90° C. are feasible when the cooling liquid of the fuel-driven generator is water. Higher temperatures are feasible when the cooling liquid is oil.

Preferably, the cooling liquid of the fuel-driven generator is configured to flow at least partially through a radiator for further cooling against an air flow generated by means of a fan, therewith generating a heated air flow. This heated air flow is supplied to the means for dehumidification. This is more particularly embodied as a regeneration module comprising a plurality of liquid channels for flow of the liquid desiccant material and a plurality of air channels for air flow. In this preferred embodiment, additional benefit is obtained from the combination of the fuel-based generator and the regeneration of liquid desiccant. Due to the use of the heated air flow, which is anyhow there, no separate means for ventilation are needed for the regeneration module. Also, because of the higher temperature, the air may absorb more humidity.

A further relevant factor of the use of the fuel-driven generator in combination with the second flow to be stored in the second container, is that the regeneration process may be decoupled in time from the use of the dehumidifier. Thus, the regeneration process may be carried out, when the generator is operated on the basis of the electricity demand. The second container filled with concentrated liquid desiccant (i.e. with the fourth humidity content) is then a battery for later use. When there is a demand for air-conditioning but merely a limited demand of electricity, the dehumidifier may then be operated on the basis of the liquid desiccant material stored in the second container, and without significant regeneration of the first flow. It is observed for clarity that the dehumidifier may operated at a low energy consumption, if the use of a heat-pump is avoided, or at least temporarily stopped, and particularly if the regeneration module for the first flow does not need to be operated at maximum flow rates and/or at high temperatures. In one further implementation, thereto, an additional container may be present for the first flow. Such additional container may be located upstream or downstream of the regeneration module. The second flow may be taken from such additional container, although other implementations are also feasible. Such situations of decoupled demands for electricity and for conditioning of air are for instance envisaged in marine air-conditioning and in resorts and other buildings in remote locations without electricity grid, particularly in areas with a tropical climate.

In one further embodiment, the cooling liquid of the fuel-driven generator is further heat exchanged over a primary heat exchanger to an intermediate cycle, in which a fluid circulates, which intermediate cycle is further provided with a secondary heat exchanger for heat exchange with the first flow of the second humidity content, so as to heat the first flow prior to a dehumidification step. More particularly, the intermediate cycle is provided with heat storage means, such as a water tank, and control means for controlling a temperature of the recirculating fluid in the intermediate cycle. In this manner, the intermediate cycle allows to smoothen differences between the amount of heat offered by the cooling liquid of the fuel-driven generator and the demand for heat by the first flow.

In one preferred implementation, additional heating means may be present so as to bring additional heat into the intermediate cycle. Such additional heating means is for instance a boiler that is at least partially driven from a solar power source. This additional heating may be useful to reduce the reliance on the generator. Moreover, additional heating may be particularly desired, if the heat in the intermediate cycle is transferred to more flows than only the first flow. For instance, in one suitable embodiment, the heat of the intermediate cycle may be further transferred to a feed solution of a membrane distillation apparatus. This use is described in the non-prepublished application PCT/NL2014/050220, which is herein included by reference. The heat demand of a membrane distillation apparatus may fluctuate considerably, since typically, the heat demand is correlated to the distillate output. Demand of clean water will vary during the day, and moreover, it is undesired to store clean water—for instance for use as potable water—over longer periods in order to prevent contamination, such as with microorganisms. In this manner, the system may convert fuel by means of the fuel-based generator, and optionally solar power, the dehumidifier, the regenerator system, and the membrane distillation apparatus into electricity, potable water or even demineralised water (for instance from sea water) and conditioned air.

The second flow is derived in accordance with a suitable embodiment of the invention at least partially from the first flow. The second flow may further be obtained from a plurality of heat and mass exchange modules. The second flow may also be partially obtained from outside the system. To the extent that the second flow is derived from the first flow, there is a plurality of options. Suitably, part of the first flow is split off. It may be collected in a container for storage of liquid desiccant that has not yet been regenerated. The second flow may be split off at any location between an entry and an exit of the heat and mass exchange module.

In one suitable embodiment the split off occurs downstream of dehumidification of the first flow to the third humidity content. Herein, the dehumidification of the first flow is effectively also used as a pre-treatment of the second flow. This allows obtaining a second flow with a lower humidity content. In one further implementation hereof, the design of the regeneration module for the first flow and for the second flow may be substantially identical.

In an alternative suitable embodiment, the split off occurs upstream of dehumidification of the first flow to the third humidity content. This is deemed beneficial to reduce the first flow through the regeneration module. Moreover, when splitting off upstream of dehumidification of the first flow and particularly upstream of any heating of the first flow, it is feasible to do heat exchanging between the regenerated and heated first flow and the split off second flow which has not been heated. Thus, in one further embodiment, a heat exchanger is provided between the regenerated and heated first flow and the split off and unheated second flow.

In an implementation, the first flow is collected from the liquid channels in a third container, which is optionally subdivided. The third container is provided with a first exit for the first flow and with a second exit for the second flow. This is deemed a robust manner of subdividing the first and the second flow. The ratio between the first and the second flow may be defined, for instance, by means of the cross-sectional areas of the first and second exit. These exits may further be provided with a valve, which can be opened and closed, suitably under control of the controller of the system.

In a further implementation, the first and the second exit are arranged such, that the liquid desiccant material leaving the first exit has a humidity content that is lower than the liquid desiccant material leaving the second exit. This further implementation is particularly suitable in combination with a cross-flow design of the heat and mass exchange module, which is a preferred implementation. This preferred implementation is disclosed in more detail with reference to the figures, and suitably contains a plurality of corrugated sheets, that are held in a spaced apart arrangement. The spaced apart arrangement is preferably achieved by means of a distance holders located at the entry of the liquid channels and with spacers located sidewise and/or at the bottom of the liquid channel. In such a cross-flow design, the liquid desiccant provided close to inlet of the air channels may become more humidified than the liquid desiccant provided closer to outlet of the air channels. In accordance with the present implementation, the liquid desiccant closer to the outlet is used as the first flow. Even if no or merely limited regeneration is carried out, the first flow could still have sufficiently low humidity content for direct re-use.

According to a further aspect, the invention provides a system comprising:
a heat and mass exchange module comprising a plurality of air channels for air flow and a plurality of liquid channels for flow of liquid desiccant material, in which heat and mass exchange module a liquid channel is arranged adjacent to an air channel with a mutual exchange surface,
a first container for liquid desiccant material for supply into liquid channels of the heat and mass exchange module;
means for dehumidification of a first flow of liquid desiccant material downstream of the heat and mass exchange module;
mixing means for mixing desiccant material from a second container into the first container and/or with the first flow downstream of the means for dehumidification.

In accordance with this aspect of the invention a conditioning system is provided, which is regenerated not merely by means of the means for dehumidification of a first flow of liquid desiccant material, such as a regeneration module, preferably preceded by a heat exchanger for heating this first flow. The regeneration is further carried out by feeding of desiccant material from a second container, which desiccant material is suitably provided at a higher concentration than the liquid desiccant material of the first flow. The desiccant material in the second container may be liquid desiccant material, solid desiccant material or a multiphase mixture of solid and liquid. The second container may be provided a component of the system. Alternatively, it could be—particularly in this embodiment—an encapsulation or container that is provided externally. For instance, it is feasible that the regeneration to obtain desiccant material in the second container is carried out at limited locations only and that second containers are offered commercially.

According to again a further aspect, the invention provides a system comprising:
a container for storing humidified liquid desiccant material;
means for dehumidification of a flow of the stored liquid desiccant material;
a second container for storage of desiccant material with an entry for the dehumidified second flow;
a fuel-driven generator for generation of electricity and heat, comprising an engine and a cooling liquid circuit for removal of the heat from the engine, and
a heat exchanger between said cooling liquid circuit and the flow of liquid desiccant material upstream of dehumidification.

In this aspect of the invention, a system is provided for regeneration of liquid desiccant by means of heat from a generator. As explained above, this system is highly advantageous, in that the heat required for conversion of the humidified liquid desiccant material into desiccant material suitable for storage in the second container matches the—relatively slow—variation in heat offered by the cooling circuit of the generator. The fuel-driven generator is more particularly a diesel generator. Preferably, the generator comprises a fan for generating an air flow, particularly for further cooling of the cooling liquid. This air flow is led to the means for dehumidification. Such means for dehumidification comprises in one embodiment a regeneration module comprising a plurality of liquid channels and a plurality of air channels with mutual exchange surfaces. The resulting dehumidified liquid desiccant material is stored in the second container, which may be provided with cooling means, examples of which have been described above. In one suitable embodiment, the system is configured such that upon cooling down the liquid desiccant material, which is more particularly an aqueous salt solution, such as an aqueous solution of a lithium salt, forms crystals of the desiccant material, as the concentration of the desiccant material exceeds a solubility limit due to cooling down. The system may then further be provided with means for separation a first phase and a second phase, which first phase is rich in crystals and which second phase is primarily or even entirely liquid. The first phase and the second phase may then be stored in separate containers, and/or directly used.

According to further aspects, the invention further relates to the use of the above described systems for regeneration of liquid desiccant material and/or for dehumidification of an air flow.

Any embodiment described hereinabove in relation to one aspect of the invention is also deemed applicable to other aspects of the invention. Furthermore, the following figure description illustrates one preferred version of a heat-and-mass exchange module. It is to be understood that the above mentioned system is most preferably implemented with the heat and mass exchange module as further illustrated and/or in varations thereof. In one particular embodiment, the module has a cross flow design, and the plates therein are arranged at a mutual distance so as to achieve laminar flow. In one further embodiment, suitably combined with the preceding one, the plates of the module are embodied as corrugated sheets having preferably a carrier layer sandwiched between two layers of wicking material. While membranes may cover the layers of wicking material, this is not deemed necessary. While the sheets may contain passages or cavities for a refrigerant, this is not deemed necessary either in the preferred embodiment as illustrated. Suitably, the number of plates per module is at least 50 and more preferably 100, so as to arrive at a mutual exchange area between the air channel and the liquid channel of at least 250 m²/m³, more preferably at least 300 m²/m³ or even at least 400 m²/m³ module.

### BRIEF INTRODUCTION TO THE FIGURES

These and other aspects of the method and the system of the invention will further be elucidated with reference to the with reference to following figures, which are not drawn to scale and are merely diagrammatical in nature. Equal reference numerals in different figures refer to identical or corresponding elements. Herein:

FIG. 1 shows a diagrammatical view of a first embodiment of a heat and mass exchange (HMX) module;

FIG. 2 shows a schematical view of a sheet used in the HMX module;

FIG. 3 shows a diagrammatical view of an implementation of such a sheet;

FIG. 4 shows in diagrammatical view the HMX module in further detail;

FIG. 5 schematically shows the system in a first embodiment;

FIG. 6 schematically shows a second embodiment of the system;

FIG. 7 schematically shows a third embodiment of the system, and

FIG. 8 schematically shows a fourth embodiment of the system.

### DETAILED DESCRIPTION OF ILLUSTRATED EMBODIMENTS

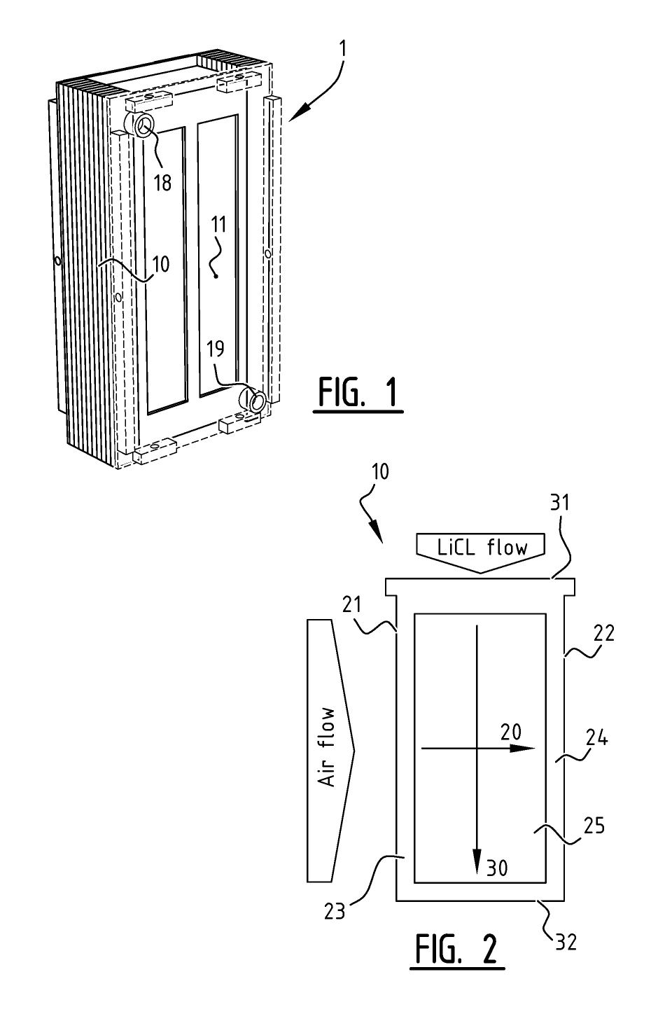

FIG. 1 shows in a diagrammatical view a module 1 for use in the invention. Although the invention may be implemented with a variety of regenerator modules and heat and mass exchange (HMX) modules, the implementation of this figure is deemed advantageous, and illustrative for understanding. Hereinafter, reference will be made to an HMX module in particular. Regenerator modules are suitably identical in design, although this is not necessary.

The HMX module 1 comprises a plurality of sheets 10. The sheets are corrugated. Due to the corrugation and its orientation, the sheets, which are inherently flexible, are sufficiently stiffened so that they can be arranged at a relative short and uniform distance of each other without risking carry-over. Each of the sheets 10 is in the preferred implementation provided with layers of wicking material 11 of both the front and the rear side of the sheet. As shown in this FIG. 1, the layer of wicking material 11 may be subdivided into two lateral portions. However, this is not deemed particularly beneficial or preferred. The HMX module 1 is designed as a cross-flow module, such that the air and the liquid desiccant run in mutually perpendicular directions through the HMX module 1. It will be clear that an entirely perpendicular design is deemed advantageous and most straightforward for manufacturing, since the sheets can be of rectangular shape.

However, this is not deemed necessary. Alternative shapes, such as that of a parallelogram, are not excluded. Preferably, the module is configured such that the air channel extends laterally and that the liquid channel of the liquid desiccant extends vertically. In this manner, the liquid desiccant will flow within the HMX module 1 under the impact of gravity. The module as shown in FIG. 1 comprises tube connections 18, 19 for the provision and removal of liquid desiccant. Their location is not deemed critical. Though not shown explicitly, it is furthermore deemed beneficial that a reservoir of liquid desiccant is present so as to overlie the sheets 10 of the HMX module. The advantage thereof is that the liquid desiccant may be distributed into and onto the layers 11 of wicking material through apertures in a bottom of such reservoir, and typically spread over the entire surface thereof. Therewith, it is prevented that an initial flow of the liquid desiccant in a lateral direction needs to be converted into flow in a vertical direction.

The HMX module as shown in FIG. 1 may be used both as a dehumidifier and as a regenerator module, but also as any other module for use in an air-conditioning system, such as a cooling module. In a dehumidifier module—also referred to as a drier module—a stream of air is dried, and the liquid desiccant takes up humidity. In a regenerator module, a flow of liquid desiccant is dried and the air in the adjacent air channel is humidified. There is no need that exactly the same design of a module is used for the dehumidifier as for the regenerator module. By means of temperature control, the dehumidifier module may further be arranged to operate as a cooler. The shown module as shown in FIG. 1 comprises a plurality of sheets. The number of sheets can be chosen as desired in dependence of climate, air volume to be conditioned and space. As apparent from FIG. 1 the liquid channel is suitably longer than the air channel, particularly in a drier module. With a well regenerated liquid desiccant, for instance an aqueous LiCl solution of sufficient concentration (i.e. typically close to the maximum loading concentration), drying turns out more effective in the first portion of the air channel. However, the liquid desiccant material does not need to be an aqueous LiCl solution, but could alternatively be a salt solution comprising various soluble salts.

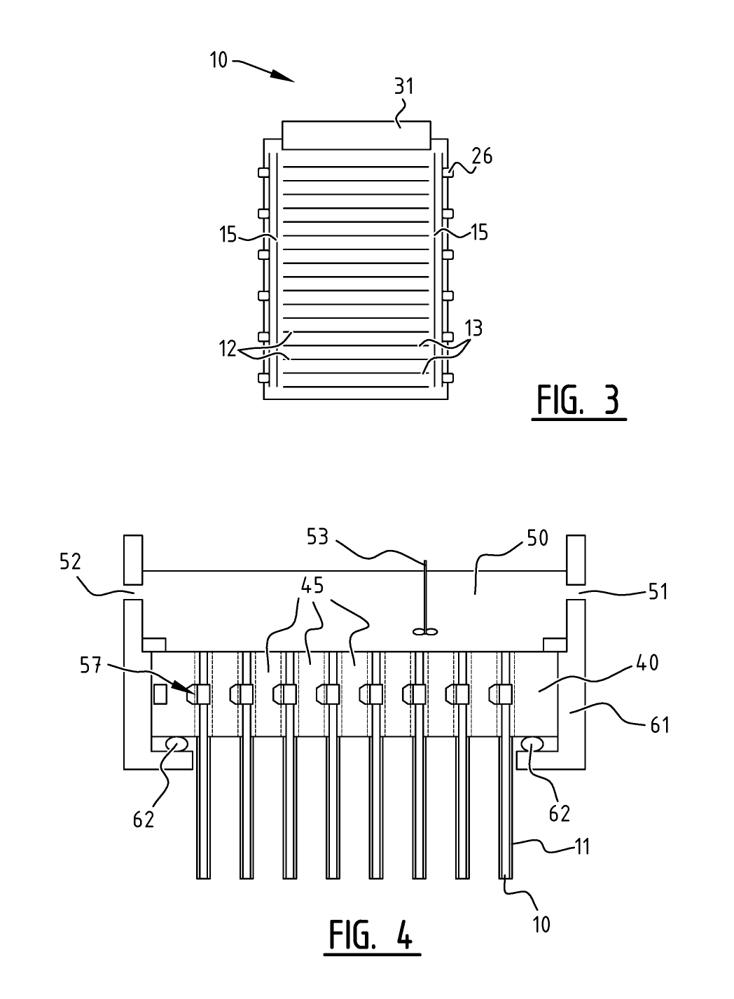

FIG. 2 shows in a schematical view a sheet 10 for use in an HMX module. An air channel 20 is defined between two sheets 10 and is indicated for sake of reference. It is configured in a lateral direction. The air channel 20 is provided with an inlet 21 and an outlet 22. Air in the air channel 20 will first pass an accommodation area 23, then an active area 25 and finally an outlet area 24. The active area 25 is configured to enable exchange with the liquid channel 30 that is defined at the surface of the layer of wicking material (on the sheet 10). It is observed for clarity that the layer of wicking material may extend beyond the active area 25. However, the active area 25 is further defined by means of the entry regions of the liquid desiccant, which are defined at the inlet 31 of the liquid channel 30. These entry regions are typically defined by means of a manifold (shown in FIG. 4). The liquid channel 30 is ended at the outlet 32. This outlet 32 is suitably embodied as a container for the liquid of several parallel liquid channels 30. It can be seen that the liquid channel 30 thus has a width (i.e. substantially as defined by the active area 25), which is smaller than the length of the air channel 20 (i.e. the distance between the inlet 21 and the outlet 22 thereof). For sake of clarity, it is observed that the term ‘air channel’ refers in the context of the present application to a volume with a length and a width and a height, with dimensions that are typically for sheets of material. More specifically, the length and the width are much larger than the height of the air channel. In one embodiment, the length and width of the air channel are substantially identical to a width and length of a sheet. Similarly, the term ‘liquid channel’ particularly refers to a liquid layer at the surface of the wicking material. The dimensions are at most equal to the dimensions of the wicking material, but may be smaller, particularly as a result of the arrangement of the entry into the liquid channel.

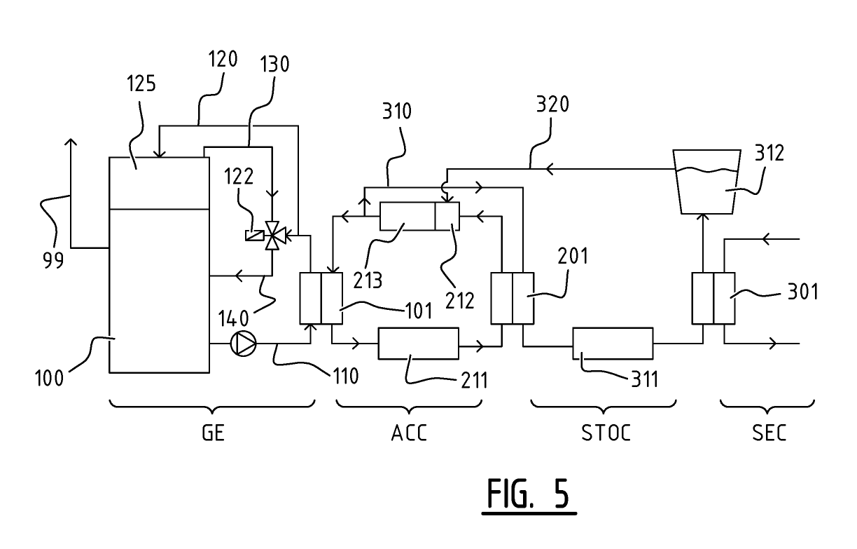

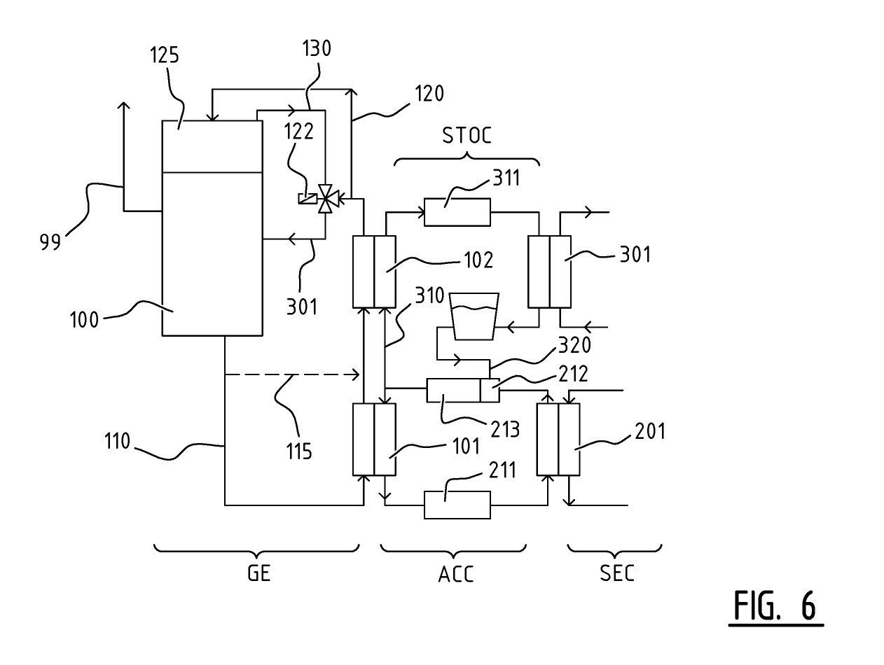

In a cross-flow design, the exchange between liquid channel and air channel in the first part of the air channel 20 is most effective. Therefore, liquid desiccant material running across this first part of the air channel 20 (in the figure at the left hand side) will—on average—be more humidified than liquid desiccant material running across a part of the air channel close to the outlet 22 (in the figure at the right hand side). Therefore, it is feasible to collect the liquid desiccant material at the bottom of the sheets 10 in two separate parts that have different humidity content. The liquid desiccant material that has run across the air channel 20 close to the outlet 22 will have lower humidity content and might be reused after mild regeneration. In accordance with one embodiment of the invention, this liquid desiccant material is transferred to a regeneration module within an air conditioning circuit (ACC in FIG. 5-8) and reused immediately. The liquid desiccant material that has run across the air channel close to the inlet 21 will have higher humidity content and is transferred to a regeneration module within a storage circuit (STOC in FIG. 5-8). In such a storage circuit, the liquid desiccant material may be heated to a higher temperature. This is enabled by means of the exchange with a cooling circuit of a fuel-driven generator. In this manner, the regeneration of the liquid desiccant material may be further improved.

FIG. 3 shows in a diagrammatical view the sheet 10 more specifically. Herein, it is indicated that the sheet 10 is provided with ridges 12 and valleys 13, in alternating arrangement. The sheet 10 suitably has a shape of a wave, wherein the ridges 12 extend into a first direction and the valleys 13 extend into the opposite direction. With these ridges 12 and valleys 13 a corrugated surface is created that is deemed positive for the necessary strength of the sheet 10, without increasing risk for carry-over. More particularly, the wave may be a sine wave. Moreover, the edges of the sheet 10 are at least substantially planar. This facilitates assembly of the sheet 10 into the module, particularly by means of a distance holder as will be explained with reference to further figures. In the shown embodiment, the ridges 12 and valleys 13 extend parallel to the width of the liquid channel 30, such that the liquid channel 30 in fact includes a curved trajectory. However, the air channel 20 is substantially planar over the width of the liquid channel, i.e. in the area where the liquid channel and the air channel have an interface. This has the advantage of minimum disturbance of air flow. As a consequence, carry over can be prevented, at least substantially, while the sheets are very thin. In this manner, a large packing density of sheets per unit volume is achieved, resulting in a large exchange area between the air channels and the liquid channels. In tests with a preliminary version of the heat and mass exchange module according to the invention, wherein the air flow was laminar and a liquid channel wave-shaped, no carry-over was found to occur. The sheet 10 is suitably created in a multistep process, comprising the provision of the carrier and one or more layers of wicking material into a provisional laminate and thereafter thermoforming of the laminate. In the course of the thermoforming, the provisional laminate is suitably bond to form the final laminate. However, the lamination process may also precede the thermoforming process.

FIG. 3 furthermore shows the presence of spacers 26, which preferably have a strip-wise extension and are assembled to a plurality of sheets 10. The spacers 26 are arranged within the accommodation area 23 and the outlet area 24, which are most preferably substantially or completely planar.

The sheet 10 shown in FIG. 4 furthermore comprises stiffening protrusions. These are arranged outside the active area 25, in which the pattern of ridges 12 and valleys 13 is arranged, and effectively within the accommodation area 23 and the outlet area 24. In the present configuration, a first and a second stiffening protrusion 15 are defined, both extending in this configuration along the width of the air channel (i.e. along the width of the active area 25 as shown in FIG. 2). While a longer stiffening protrusion is deemed beneficial, it is not excluded that this long protrusion is subdivided into two or more shorter protrusions. Moreover, more protrusions could be present, particularly in the accommodation area and in the outlet area. This is however neither deemed necessary nor deemed advantageous. Both protrusions 15 have the same dimensions in this configuration. Again, this may be useful, so as to obtain a design that is most symmetrical, but it does not appear necessary.

FIG. 4 shows the HMX module 10 more detail, and particularly the connection to an overlying reservoir 50. The sheets 10 are herein kept together by means of strips 45 that are provided with a plurality of clamps 57, present at side faces of the sheets 10. The strips are designed so as to create entry channels, through which liquid desiccant material can flow in and onto a surface of the layer of wicking material 11. Side walls 61 are present at the outside, so that the assembly of sheets and strips may be fixed and contained, particularly by means of a pressing operation. O-rings 62 may be present to avoid leakage of liquid desiccant along the walls 61. Although not shown, it would be perfectly possible to insert a bottom of the reservoir in the form of a sheet with apertures.

The reservoir 50 is suitable for use as a first container in accordance with the invention. As shown in this FIG. 4, the reservoir 50 is provided with a first inlet 51, with a second inlet 52 and with a stirrer 53. According to one embodiment of the invention, the first inlet 51 is used for liquid desiccant material that has been regenerated directly, i.e. within the air conditioning circuit (ACC in FIG. 5-8). The second inlet 52 is used for liquid desiccant material that has been regenerated separately and is provided from a second container (not shown in this Figure). The first and the second inlet 51, 52 may be provided with switchable valves so as to vary the mutual ratio of the first flow through the first inlet 51 and the third flow through the second inlet 52. In the shown embodiment, the second inlet 52 is configured for a solution, dispersion or suspension. In one further implementation (not shown), the second inlet may be configured as a plurality of inlets across the side wall 61 or a top side of the reservoir 50. This may contribute to distribution. The stirrer 53 is one implementation of mixing means. Rather than using a stirrer (for instance mechanical or magnetic), mixing may further be achieved by designing the reservoir such that the flows are mixed together.

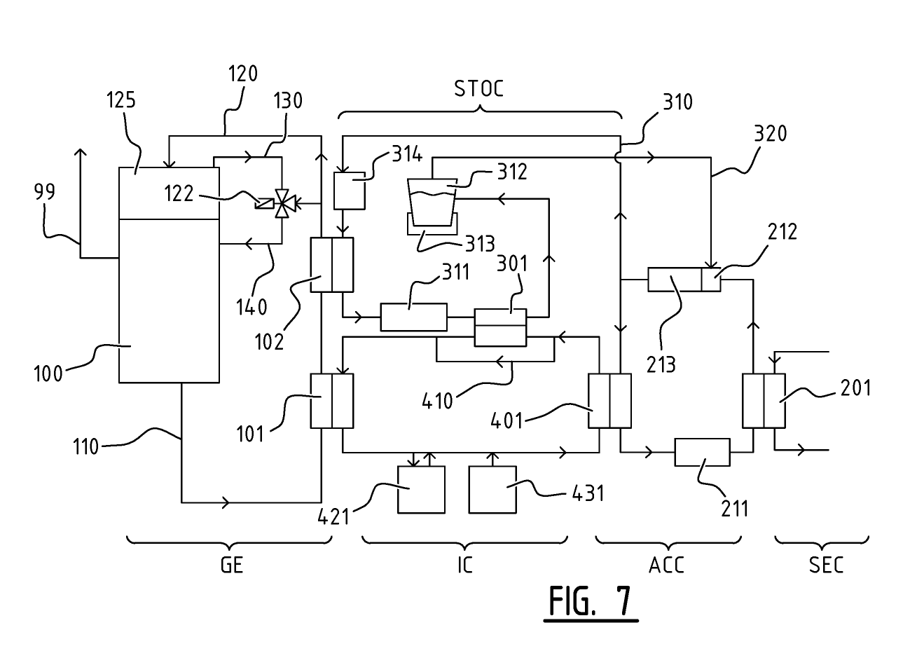

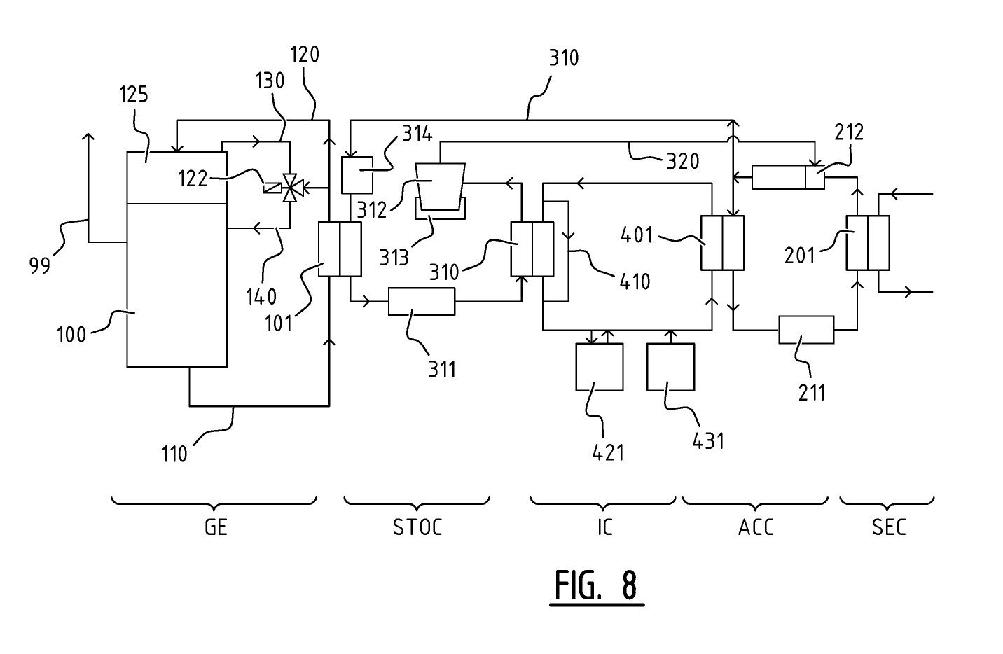

FIG. 5 schematically shows a first embodiment of the system of the invention. In this embodiment, as well as in the further embodiments shown in FIG. 6-8, several circuits are present: a generator circuit GE, an air conditioning circuit ACC, a storage circuit STOC and a water cooling circuit SEC. The water in the water cooling circuit SEC is for instance sea water. FIGS. 7 and 8 further show an intermediate circuit IC. For sake of simplicity, the individual circuits GE, ACC, STOC, SEC, IC are shown in simple implementations in the various figures. These individual circuits will be discussed first.

The generator GE comprises an engine 100 that generates a stream of electricity 99. The fuel generator GE is suitably a diesel generator, although other types of generators are not excluded. In order to dissipate heat generated in the course of electricity generation, the engine 100 is provided with three ‘layers’ of heat dissipation means: an internal cooling circuit (not shown), an (external) cooling circuit 110, 140 and a radiator based cooling circuit 120, 130. Conventionally cooling liquid will flow first through the cooling circuit 110 and then via the radiator cooling circuit 120, 130, 140 back to the engine. The heat dissipation of the cooling circuit 110 is constituted by one or more heat exchangers 101, 102. If the transfer of heat in the heat exchangers 101, 102 is sufficient to cool down the medium to a predefined temperature, as sensed and controlled by means of regulation means 122, the medium will flow back into the circuit element 140 and bypass the radiator cooling circuit 120, 130.

A third, suitable layer of heat dissipation means is defined by the radiator cooling circuit 120, 130, in which heat is actively dissipated in heat dissipation means 125. This heat dissipation means 125 are suitably embodied as a radiator. A fan or the like—not shown—is preferably present for air convection and therewith efficient heat dissipation from the radiator 125. The fan is typically driven directly from the engine 100.

This cooling circuit 110 may be operated and designed on the basis of oil as a medium, or alternatively an aqueous medium, such as a mixture of water and glycol. Since the temperature of the oil is significantly higher than the aqueous medium, the operation of the system of the invention, and suitably also the design of the generator GE, will be different dependent on the type of medium. The use of an oil as a cooling medium is advantageous in that its temperature typically lies above 100° C., for instance between 110° C. and 125° C. This allows, without too much complications, to transfer sufficient heat from the generator via a heat exchanger 101 to the storage circuit STOC. Such high temperature may result therein that the humidity in liquid desiccant material will evaporate very easily. The humidity content may then be reduced easily, also to humidity contents that are significantly lower than those reached in a direct regeneration process.

Alternatively, the cooling medium of the cooling circuit of the generator is aqueous, such as water or a water-glycol mixture. This further embodiment allows making use of an installed base of diesel generators, since a liquid-cooled diesel generator is very common and in use in many service and office locations worldwide, such as hotels, hospitals, offices. In such an embodiment, use may be made of an intermediate circuit IC as shown in FIGS. 7 and 8. This allows to add further sources of heat, such as a boiler, and to provide heat storage means, such as a hot water storage tank. In this manner, the heat dissipation required by the diesel generator may be matched with the energy demand of the air conditioner circuit ACC. If desired, further apparatus operating on the basis of hot water may also be coupled to such intermediate circuit IC. One further advantage of an intermediate cycle, particularly with additional heat sources is that hot water may be easily transported through a system of tubes without risk for corrosion or the like, or without a need for separate tubings in material prone to the liquid desiccant material.

The boiler and/or a hot water storage tank is in this embodiment required for preheating the medium of the intermediate cycle after that it has been cooled in the secondary heat exchanger. The boiler and/or a hot water storage tank is therefore, most preferably, located stream upwards from the primary heat exchanger. The reason thereof is a prevention of a so-called cold motor effect, meaning that if the temperature of the cooling medium of the generator falls down below a minimum temperature, the generator will shut off its cooling circuit, relying only on its internal circuit. Such minimum temperature is for instance 78° C. However, for some types of membrane distillation apparatus, the temperature of the medium of the intermediate cycle after passing the secondary heat exchanger is lower, for instance 70-72° C. In other words, unless said medium is preheated, there is no viable steady-state operation of the system.

The advantage of the diesel generator, particularly one that is cooled with an aqueous cooling liquid, is that the temperature operation window of the cooling liquid matches very well with the temperatures needed for the regeneration process. Therewith, an effective reuse becomes feasible.

The air-conditioner circuit ACC is in fact a circuit comprising both a dehumidifier 213, for instance a heat and mass exchange module, such as shown in FIG. 1-4, and a regenerator 211, which is preferably embodied as a heat and mass exchange module. The air-conditioning circuit ACC comprises a heat exchanger for heating a first flow of liquid desiccant material and arranged downstream of the dehumidifier 213 and upstream of the regenerator 211. The air-conditioning circuit ACC further comprises a heat exchanger 201 downstream of the regenerator 211 for cooling the first flow after regeneration. The air-conditioner circuit ACC may further contain an evaporative cooler, which is however not shown.

In accordance with the invention, the air-conditioning circuit ACC further comprises a first container 212, which may be embodied as a reservoir on top of the heat and mass exchange module such as shown in FIG. 4. However, the first container 212 could alternatively be a separate vessel. It will be understood that a separate vessel and a reservoir as shown in FIG. 4 could both be present. The first container 212 does not merely have an inlet for liquid desiccant material from the regenerator 211, typically reduced in temperature in heat exchanger 201. The first container 212 also has an inlet for liquid desiccant material stored in the second container 312, and transported to the first container 212 by means of line 320, as the third flow. Furthermore, a subdivision is present, so as to split the second flow (running in line 310) off from the first flow (in the ACC). Although not shown in any of the present figures, the inlet line 310 could be split off from the air-conditioning circuit ACC also downstream of the regeneration module 211, rather than downstream of the dehumidifier 213. This is a matter of design. However, in one suitable embodiment, the heated first flow is heat exchanged in the heat exchanger 201 against the second flow that is still cold. Such a heat exchange that is feasible without a heat pump, is an effective way of reducing the temperature of the heated first flow without too aggressive use of the water cooling circuit SEC. Although not shown in these figures for sake of clarity, it is not excluded that the air-conditioning circuit ACC includes a further heat exchanger downstream of the shown heat exchanger 201, so that the circuit ACC contains at least one heat exchanger with the water cooling circuit SEC. Furthermore, it may be that a plurality of dehumidifiers 213 is present within the air-conditioning circuit ACC, for instance for air conditioning of several spaces (rooms) within a building. These dehumidifiers 213 are suitably arranged in series. It is most beneficial that each humidifier 213 is then provided with its first container 212, so as to allow separate regulation of the air conditioning. However, this may not be most cost-effective.

The storage circuit STOC is operated by means of the second flow entering via line 310. After regeneration and storage, a third flow of liquid desiccant material leaves the storage circuit STOC via line 320. For sake of clarity, it is observed that a plurality of air-conditioning circuits ACC may be coupled to a single storage circuit STOC. In a storage circuit STOC, the liquid desiccant material is first heated by means of a heat exchanger, then regenerated by means of regeneration module 311 and thereafter stored in the second container 312. A third container 314 may be present (as shown in FIGS. 7 and 8) to collect a liquid desiccant material from the air-conditioning circuit ACC.

In one embodiment, a heat exchanger 301 is present downstream of the regeneration module 312 for cooling the liquid desiccant material. In another embodiment, the second container 312 may be cooled, for instance by means of a water bath 313 (shown in FIGS. 7 and 8). There may well be further options for cooling. Since the liquid desiccant material may be stored during a longer period in the second container 312, cooling may be more gradual. This longer period is for instance a part of a day, for instance up to a full day, but could even be much longer. For instance, the second storage container 312 may be embodied as an arrangement of a plurality of channels, mutually spaced apart by water channels from which water may evaporate and therewith gradually cool the liquid desiccant material. It is for instance known that thin sheets of polypropylene are suitable for transmission of heat, and this polypropylene is further not resistant against concentrated salt solutions such as lithium salts, for instance lithium chloride aqueous solutions, such as solutions with a weight percentage of lithium chloride above 40 wt %. The liquid desiccant material could be regularly pumped around in such a configuration to prevent too much local crystallisation. In again a further embodiment, crystallisation of lithium chloride may be envisaged, and the second container 312 may be designed thereto, for instance by including of separation means of a predominantly liquid phase (for instance a solution or a dispersion) and a crystalline phase (i.e. a phase containing a substantial amount of crystals, such as a suspension). A centrifuge may be a suitable separation means. An additional benefit of crystallisation of lithium chloride is that it cools on crystallisation and that it warms on dissolution. Therefore, when letting LiCl crystallize, the solution will cool down. When removing the solution from the formed crystals, a cooled solution can be obtained.

While not indicated in the Figures for sake of simplicity, the air flowing through the radiator may be led to a regenerator module 211, 311 so as to take up humidity from the liquid desiccant material. This safes a separate fan. Preferably, use is made of air flow for a regenerator module 211, 311 that is located close to the generator GE. It appears that this is typically the regenerator module 311 of the storage circuit STOC, since that is least bound to locations, wherein dehumidification is required.

Turning to FIG. 5, this Figure shows a system architecture wherein the cooling circuit 110 of the generator GE is coupled in heat exchanger 101 to the air-conditioning circuit ACC, so as to heat the first flow upstream of the regeneration module 211. Heat remaining after the regeneration of the liquid desiccant material is then transferred to the storage circuit STOC via heat exchanger 201. The storage circuit STOC is again cooled in heat exchanger 301 against the water cooling circuit SEC. This system architecture is deemed suitable for a generator that is water cooled and particularly in situations wherein it is expected that the generator runs always when air-conditioning such as dehumidification is demanded. At periods wherein less dehumidification is demanded, the heat is further transmitted to the storage circuit STOC for conversion. A third flow of liquid desiccant material may then be added to the first container 212 and the dehumidifier when there is a peak demand for air conditioning, and/or when there is a need for enhanced dehumidification.

For sake of clarity it is thus observed that the first flow runs through the air conditioning circuit ACC. Upstream of the dehumidifier module 213, more particularly in the first container 212, it has a first humidity content. Downstream of the dehumidifier module 212, it has a second humidity content, which is higher than the first humidity content. Downstream of the regeneration module 211, the second humidity content is reduced to the third humidity content. In accordance with the invention, the third humidity content may still be higher than the first humidity content. It could always be higher. It could alternatively be higher temporarily, for instance when the air-conditioning demand is temporarily very high. The first humidity content is nevertheless maintained (or achieved, if the first humidity content would increase) by adding a third flow originating from the second container 312 with a fourth humidity content. The fourth humidity content is suitably higher than the third humidity content of the first flow, so as to keep up the first humidity content. Alternatively, the first, the third and the fourth humidity contents may be identical, or identical within a margin of tolerance. The advantage of the invention is then that the first flow through the regeneration module 211 may be reduced or even interrupted and that the regeneration is achieved by introducing the third flow from the second container 312 wherein concentrated liquid desiccant material (with the fourth humidity content) has been stored. The latter mode of operation is for instance deemed beneficial for locations without access to an electricity grid, wherein a generator is operative in certain periods and inoperative in other periods. It is observed that the use of a fuel-driven generator GE, such as a diesel generator for the transfer of heat to an air-conditioning circuit ACC is also advantageous without storage circuit STOC.

Herein, the generator circuit GE is modified with respect to a conventional generator through the addition of the switching means 122, which allows the creation of a bypass between the cooling circuit 110 and the return path 140 to the engine without passing the radiator 125. It has been observed in experiments leading to the invention that a continuous heat transfer from the cooling circuit 110 allows that the fan for generation of an air flow through the radiator 125 may be operated at a constant relatively low rate rather than at varying speed. This reduction of speed of the fan reduces the load on the generator GE, provoking a reduced fuel use of some percentages, for instance 4% of more. The set up may be further enhanced, in that the air flow generated by the fan ‘behind’ the radiator 125 may be led to the regenerator 211. This safes a separate fan, further reducing load on the generator GE. Hence, the invention also relates to a method of dehumidifying air, wherein use is made of a heat and mass exchange module comprising a plurality of air channels for air flow and a plurality of liquid channels for flow of liquid desiccant material, in which heat and mass exchange module a liquid channel is arranged adjacent to an air channel with a mutual exchange surface. This method further comprises the steps of (1) providing liquid desiccant material with a first humidity content into a first container; (2) supplying a first flow from the first container into liquid channels of the heat and mass exchange module for exchange with an air flow at the mutual exchange surface, resulting in a dehumidified air flow and in humidification of the liquid desiccant material to a second humidity content; (3) regenerating the first flow, and (4) adding the regenerated liquid desiccant material into the first container for supply into the heat and mass exchange module. Herein the regenerating process comprises the steps of heating the second flow in a heat exchanger against a flow of cooling liquid from a fuel-driven generator to a first temperature, and dehumidifying the second flow at the first temperature. Particularly, in one suitable embodiment, use is made of a thermovalve between the cooling liquid circuit and a radiator circuit, such that in dependence of the temperature of the cooling liquid, a flow of cooling liquid through the radiator circuit for further cooling down may be controlled. Particularly, such thermovalve carries out such control automatically. This process may be carried out in a corresponding system. This process may further be carried out in an arrangement, wherein an intermediate circuit as shown in FIGS. 7 and 8 is present between the air-conditioning circuit ACC and the generator circuit GE.

FIG. 6 shows the system architecture of the system according to a second embodiment. Herein, the cooling circuit 110 of the generator GE is provided with a first and a second heat exchanger 101, 102. The first heat exchanger is coupled to the air conditioning circuit ACC. The second heat exchanger 102 is coupled to the storage circuit STOC. In this manner, the heat transfer from the cooling circuit 110 of the generator GE is not limited by the capacity of the air conditioning circuit ACC. The arrangement of the heat exchangers 101, 102 is in series, such the first heat transfer occurs to the air-conditioning circuit ACC. However, a by-pass 115 is optionally present, resulting in a parallel configuration. The arrangement of the air conditioning circuit ACC and the storage circuit STOC may alternatively be reserved. That could be efficient when using an oil-cooled generator, or a water-cooled generator with a relatively high temperature of the cooling medium. The temperature of the cooling liquid could then be too high for the first flow in the air-conditioning circuit ACC. Furthermore, both the air conditioning circuit ACC and the storage circuit STOC are provided with a heat exchanger 201, 301 for heat exchange to a water cooling circuit SEC. While the FIG. 6 shows a heat exchanger 102 with the two flows running in parallel, this is not essential.

FIG. 7 shows the system architecture of the system, in simplified form, according to a third embodiment. In this third embodiment, an intermediate circuit IC is present, in which a cooling medium, such as water or an aqueous solution is circulated. The temperature of this cooling medium is then regulated, so as to ensure that the demands of the first flow in the air conditioning circuit ACC are met. If additional heat remains, such heat may be stored in heat storage means 421, such as a vessel for containing water of a predefined temperature. A first vessel may be present for containing a surplus of heat, and is preferably located downstream of the heat exchanger 101 with the cooling circuit of the generator GE. The stored heat may put back into the intermediate circuit IC at a later moment, for instance for boosting the transfer of heat. The stored heat could also be removed, if thus needed. A further vessel—not shown may be present to contain an additional volume of water that has been cooled in passing a further heat exchanger 401. The storage vessels are for instance embodied as thermally isolated vessels, of the type known as Dewar vessels. If desired, the hot water storage vessel may be a storage under pressure, resulting in an additional liberation of energy in the form of heat, when hot water is released from said storage vessel. The storage vessels could further be coupled to the boiler, so as to allow increase of temperature of the stored liquid.

In the preferred embodiment shown in FIG. 7, the intermediate circuit IC is further provided with a boost heating means 431. Such a boost heating means are intended for additional heating of the fluid in the intermediate circuit IC. Particularly, this additional heating may be started up and stopped more rapidly that the provision of heat via the heat exchanger 101 from the generator GE.

Therefore, the boost heating means can be used in several situations, such as during a start-up of the generator GE, when the heat supplied via the heat exchanger 101 is insufficient; as an additional heating means, for instance a solar power source; and/or as a temporary boost. The boost heating means 431 are for instance embodied as a boiler. The boiler may be any type of boiler, and is suitably fed with electricity, at least partially, from the generator GE.

The location of the heat storage means 421 and additional heating means 431 is open to further design. It may well be suitable to provide additional containers in the intermediate circuit IC, one for the heated water and the other for the cooled water. This allows that the temperature of the cooling liquid flowing back to both the heat exchanger 101 with the generator GE and to the alternative power source, such as a solar power source, is identical. The provision of such containers could also prevent overflow or insufficient flow as a consequence of different flow rates.

In the shown embodiment, the intermediate circuit IC is further provided with a bypass 410 around a heat exchanger 301 with the storage circuit STOC. Suitably the bypass is provided with a valve that is operated under control of a controller. The bypass 410 would be opened when the temperature in the intermediate circuit IC would be higher than that in the storage circuit STOC, such that heating rather than cooling of the regenerated liquid desiccant material in the storage circuit STOC would occur. This third embodiment may be very effective if not merely the air-conditioning circuit ACC but also further heat-consuming circuits (not shown) are coupled to the intermediate circuit IC. One example is for instance the addition of a membrane distillation apparatus. In such situation, a large heat demand is expected, resulting therein that the transfer of heat from the cooling circuit 110 via heat exchanger 101 is effective, but there may nevertheless be periods in which the amount of heat is insufficient for complete regeneration on the basis of the regeneration module 211 only. Then, a third flow of liquid desiccant material may be transferred into the first container 212 from the second container 312.

FIG. 8 shows a system architecture of the system in a fourth embodiment. This embodiment is similar to the third embodiment. However, the intermediate circuit IC is not directly coupled to the cooling circuit 110 of the generator GE, but only via the storage circuit STOC. In fact, the principle underlying this fourth embodiment is that the heat from the generator GE is primarily used for storage circuit STOC and the generation of concentrated liquid desiccant material stored in the second container 312. The direct regeneration of the air-conditioning circuit ACC is operated on the basis of the heat from the intermediate circuit IC. This heat may be based as much on a solar power source 431 as on the heat transferred from the storage circuit STOC. While the direct regeneration in the regeneration module 211 may be less effective, the present embodiment allows—just as the preceding embodiments, but even more pronounced—that the humidity content of the first flow in the air-conditioning circuit ACC is further reduced by addition of a third flow of more concentrated desiccant material into the first container 212. This third flow is added in the shown embodiment via transportation line 420 from the second container 312. Since the heat transferred into the air-conditioning circuit ACC via the heat exchanger 401 may be less, the temperature of the first flow downstream of the regeneration module 211 may be less high, and cooling against the water cooling circuit SEC—such as sea water—via heat exchanger 201 is feasible.

The decoupling of the air-conditioning circuit ACC from the generator GE, such as shown in FIG. 7 and FIG. 8, seems furthermore beneficial for applications wherein dehumidifiers and the generator are arranged remote from each other. Herein the intermediate circuit IC allows transportation over longer distances. Moreover, the concentrated liquid desiccant material in the second container 312 allows transportation over a longer distance. One of the options thereto is transportation of the container 312 in its entirety.

The beneficial operation of the invention may be fully understood with an example of a remote location. At such locations, fuel is expensive and generators are typically run merely several hours per day. In one exemplary embodiment, a 100 kW generator is present that runs every day 9 hours, 3 hours in the morning and 6 hours in the evening. Thus results in a total of 900 kWh of heat, since a typical efficiency of a diesel generator is that for each kW electricity a kW on heat is produced and needs to be dissipated. Air conditioning is however required 24 hours per day. By converting the heat in concentrated liquid desiccant material during the hours in which the generator is active, this 900 kWh can be stored. This allows cooling of a space with 37.5 kW continuously. If heat can be added via a solar power source, the cooling capacity even increases. For this embodiment, it appears suitable, that several regenerator modules 311 are coupled in parallel, and/or several storage circuits STOC are provided, so as to profit from the temporary heat as much as possible.

The use of the invention by means of a desiccant battery furthermore appears very advantageous for marine applications. Particularly, when a ship moves, there is abundant availability of heat from the generator, more particularly a diesel engine. This allows for concentrating the liquid desiccant material into the second containers for storage, similarly to the charging of a battery. The system for such marine applications may be configured that heat from the cooling circuit 110 of the generator GE is transferred into the storage circuit STOC by means of heat exchanger 101. A difference with the embodiments shown in FIGS. 5-8 is that the cooling liquid from this cooling circuit 110 may be disposed into the sea or other water rather than returning to the generator GE. However, this is more a matter of the design of the generator GE. This heat exchanger 101 could be integrated with the regenerator module 311. Clearly, a plurality of storage circuits STOC may be provided in parallel to each other.

The concentrated desiccant material stored in the second container 312 may be used, when the ship enters a port and the engine is not needed for the transmission of the ship. In fact, the engine may then be switched off and the air conditioning can continue running on the basis of the available concentrated desiccant material, such as liquid desiccant material but optionally even a suspension of crystals in liquid desiccant material. The cooling may again be carried out by means of the water cooling circuit SEC, from outside the boat, or by means of water that has been taken before. The necessary electricity may then be obtained from batteries, since the pumps and the like do not have a high demand of electricity. Such a solution is not merely beneficial for small ships, but also for large ships, such as cargo ships, wherein air-conditioning is required for maintenance of the transported goods. The solution is also feasible for big passenger ships. In fact, in larger ships, it may be beneficial to arrange decoupling of the second containers, so as to move the desiccant material from the location of the engine to passenger decks at a higher location within the ship.

Thus, in short, the air-conditioning system of the invention comprises a dehumidifier and a regenerator, particularly in the form of modules of sheets with wicking material defining liquid channels. The dehumidifier and regenerator are arranged such that a first flow of liquid desiccant material may run in a cycle between those. The system also comprises a first container for the liquid desiccant material for supply into the dehumidifier. Furthermore, the system is provided with a second regenerator for generation of a second flow of liquid desiccant material and a second container for storage of desiccant material with an entry for the dehumidified second flow. It further comprises mixing means for mixing desiccant material from the second container into the first container and/or with the first flow upstream of the dehumidifier. Particularly, the second flow is heated prior to regeneration by means of a heat-exchanger drawing heat—directly or indirectly—from a cooling liquid of a fuel-driven generator. The invention further relates to a method of air-conditioning using such a system. The provision of a second container with concentrated liquid desiccant material enlarges operation flexibility. The drawing of heat from the generator furthermore matches the regeneration of the second flow for storage, with respect to quantities of liquid desiccant material that are regenerated and the ability to discontinue regeneration of the second flow, if the generator, that is typically operated in order to generate electricity, is stopped or operated in a low mode with generation of less heat.

1. A method of dehumidifying air, wherein use is made of a heat and mass exchange module comprising a plurality of air channels for air flow and a plurality of liquid channels for flow of liquid desiccant material, in which heat and mass exchange module a liquid channel is arranged adjacent to an air channel with a mutual exchange surface, which method comprises the steps of:
Providing liquid desiccant material with a first humidity content into a first container;
Supplying a first flow from the first container into liquid channels of the heat and mass exchange module for exchange with an air flow at the mutual exchange surface, resulting in a dehumidified air flow and in humidification of the liquid desiccant material to a second humidity content;
Regenerating the first flow, and
Adding the regenerated liquid desiccant material into the first container for supply into the heat and mass exchange module,
Wherein the regenerating process comprises the steps of:
Dehumidifying the first flow with the second humidity content to a third humidity content;
Dehumidifying a second flow of liquid desiccant material to a fourth humidity content, which is at most equal to the first humidity content;
Storing the second flow with the fourth humidity content in a second container;
Mixing a third flow of desiccant material from the second container with the first flow with the third humidity content to obtain a liquid desiccant material of the first humidity content.

2. The method as claimed in claim 1, wherein the dehumidification of the second flow of liquid desiccant material comprises the steps of:
Heating the second flow in a heat exchanger against a flow of cooling liquid from a fuel-driven generator to a first temperature;
Dehumidifying the second flow at the first temperature.

3. The method as claimed in claim 2, wherein:
the dehumidification of the second flow is carried out in a regeneration module comprising a plurality of liquid channels for flow of the liquid desiccant material and a plurality of air channels for air flow;
the cooling liquid of the fuel-driven generator is configured to flow at least partially through a radiator for further cooling against an air flow generated by means of a fan, therewith generating a heated air flow, and
the heated air flow is supplied into the air channels of the regeneration module.

4. The method as claimed in claim 1, wherein the liquid desiccant material is cooled down during storage in the second container.

5. (canceled)

6. The method as claimed in claim 1, wherein the second container is decoupled from means for supplying the second flow, when the liquid desiccant material in the second container reaches a predefined level.

7. (canceled)

8. The method as claimed in claim 1, wherein the dehumidification to the fourth humidity content is chosen such that after cooling the liquid desiccant material solidifies at least partially.

9. (canceled)

10. (canceled)

11. The method as claimed in claim 2, wherein the cooling liquid of the fuel-driven generator is further heat exchanged over a primary heat exchanger to an intermediate cycle, in which a fluid circulates, which intermediate cycle is further provided with a secondary heat exchanger for heat exchange with the first flow of the second humidity content, so as to heat the first flow prior to a dehumidification step.

12. The method as claimed in claim 11, wherein the intermediate cycle further is provided with heat storage means and with an additional heating means, and wherein a temperature of the circulating fluid is controlled.

13. (canceled)

14. The method as claimed in claim 2, wherein the fuel-driven generator is a diesel generator.

15. The method as claimed in claim 1, wherein part of the first flow is split off into the second flow.

16. (canceled)

17. (canceled)

18. The method as claimed in claim 15, wherein the first flow is collected in a third optionally subdivided container, with a first exit for the first flow and a second exit for the second flow.

19. The method as claimed in claim 18, wherein the first and the second exit is arranged such, that the liquid desiccant material leaving the first exit has a humidity content that is lower than the liquid desiccant material leaving the second exit.

20. A system comprising:
a heat and mass exchange module comprising a plurality of air channels for air flow and a plurality of liquid channels for flow of liquid desiccant material, in which heat and mass exchange module a liquid channel is arranged adjacent to an air channel with a mutual exchange surface;
a first container for liquid desiccant material for supply into liquid channels of the heat and mass exchange module;
means for dehumidification of a first flow of liquid desiccant material downstream of the heat and mass exchange module;
means for dehumidification of a second flow of liquid desiccant material
a second container for storage of desiccant material with an entry for the dehumidified second flow;
mixing means for mixing desiccant material from the second container into the first container and/or with the first flow downstream of the means for dehumidification.

21. The system of claim 20, further comprising a fuel-driven generator with a cooling liquid circuit, and a heat exchanger between said cooling liquid circuit and the second flow of liquid desiccant material upstream of dehumidification.

22. The system as claimed in claim 20, wherein
the fuel-driven generator further comprises a fan and a radiator for temperature reduction of the cooling liquid in the cooling liquid circuit downstream of the heat exchanger;
the means for dehumidification of the second flow comprise a regeneration module comprising a plurality of air channels for air flow and a plurality of liquid channels for flow of liquid desiccant material, in which heat and mass exchange module a liquid channel is arranged adjacent to an air channel with a mutual exchange surface;
the system is configured such that an air flow generated by the fan and heated by the radiator is led into the regeneration module.

23. The system as claimed in claim 20, wherein the second container is provided with cooling means.

24. The system as claimed in claim 20, further comprising an intermediate cycle in which a fluid circulates, a primary heat exchanger between the cooling liquid circuit of the fuel-based generator and the fluid of the intermediate cycle, and a secondary heat exchanger for heat exchange between the circulating fluid and the first flow, said secondary heat exchanger being arranged downstream of the heat and mass exchange module and upstream of the means for dehumidification of the first flow.

25. The system as claimed in claim 24, wherein the intermediate cycle further is provided with heat storage means and with an additional heating means, and wherein the system comprises a controller configured for controlling a temperature of the circulating fluid in the intermediate cycle.

26. The system as claimed in claim 24, further comprising a further heat exchanger with a cooling medium downstream of said means for dehumidification of the first flow.

27. The system as claimed in claim 20, further comprising a controller configured to control a humidity content in the first container.
